(19) United States
(12) Patent Application Publication
(10) Pub. No.: US 2021/0183545 A1
(43) Pub. Date: Jun. 17, 2021

(54) PARAMAGNETIC MATERIALS AND ASSEMBLIES FOR ANY MAGNETOCALORIC OR THERMOELECTRIC APPLICATIONS

(71) Applicant: Heat X, LLC, Auburn Hills, MI (US)

(72) Inventor: Miguel A. Linares, Bloomfield Hills, MI (US)

(21) Appl. No.: 17/120,440

(22) Filed: Dec. 14, 2020

Related U.S. Application Data
(60) Provisional application No. 62/947,102, filed on Dec. 12, 2019.

(51) Int. Cl. H01F 1/00; H02K 1/27; H01F 1/01

(52) U.S. Cl. CPC H01F 1/0036; H01F 1/015; H02K 1/276

(57) ABSTRACT

The present disclosure concerns materials and compositions for application to an inductive heating or cooling and/or magnetocaloric and/or thermoelectric heating or cooling apparatus. The present disclosure provides, in part, materials and compositions for application in a thermoelectric cell or Peltier cell. The present disclosure further provides, in part, paramagnetic materials and compositions are optimized for use in inductive heating or magnetocaloric or thermoelectric cooling and/or heating devices in order to provide consistent magnetic susceptibility and high thermal conductivity properties.

### CROSS REFERENCE TO RELATED APPLICATIONS

This application claims priority to U.S. Provisional Patent Application 62/947,102, filed Dec. 12, 2019, the contents of which are hereby incorporated by reference in their entirety.

### FIELD

The present disclosure concerns the application of alloys for providing a solid-state temperature change through the application of a magnetic field and/or an electric current.

### BACKGROUND

The magnetocaloric effect (MCE), or adiabatic temperature change (ΔTad), is generally detected as the heating or the cooling of magnetic materials due to a varying magnetic field. In practice, all atoms respond in some way to magnetic fields, but they respond differently depending on the configuration of the atoms surrounding the nucleus. Depending on this configuration, an element can be diamagnetic, paramagnetic or ferromagnetic.

Elements that are diamagnetic, which is actually all of them to a degree, are weakly repelled by a magnetic field, while paramagnetic elements are weakly attracted and can become magnetized. Ferromagnetic materials also have the ability to become magnetized, but unlike paramagnetic elements, the magnetization is permanent. Both paramagnetism and ferromagnetism are stronger than diamagnetism, so elements that exhibit either paramagnetism or ferromagnetism are no longer diamagnetic.

Only a few elements are ferromagnetic at room temperature. These include iron (Fe), nickel (Ni), cobalt (Co), gadolinium (Gd) and, as recently discovered, ruthenium (Ru). A permanent magnet can be made with any of these metals by exposing the metal to a magnetic field.

The list of paramagnetic atoms is much longer. A paramagnetic element becomes magnetic in the presence of a magnetic field, but it loses its magnetic properties as soon as you remove the field. The reason for this behavior is the presence of one or more unpaired electrons in the outer orbital shell.

Every atom has a cloud of negatively charged electrons and the potential for magnetic properties, but whether the atom displays ferromagnetism, paramagnetism or diamagnetism depends on the electron configuration. In determining how electrons decide which orbits to occupy around the nucleus, the electrons have a quality called spin, which is roughly a direction of rotation.

Electrons can further exhibit a “spin-up” (which can be visualized as clockwise rotation) or “spin-down” (counterclockwise). They arrange themselves at increasing, strictly defined distances from the nucleus called shells, and within each shell are subshells that have a discrete number of orbitals that can be occupied by a maximum of two electrons, each having opposite spin. Two electrons occupying an orbital are said to be paired. Their spins cancel and they create no net magnetic moment. A single electron occupying an orbital, on the other hand, is unpaired resulting in a net magnetic moment.

Diamagnetic elements are those with no unpaired electrons. These elements weakly oppose a magnetic field, which scientists often demonstrate by levitating a diamagnetic material, such as pyrolitic graphite over a strong electromagnet. Paramagnetic elements are those that do have unpaired electrons. They give the atom a net magnetic dipole moment, and when a field is applied, the atoms align with the field, and the element becomes magnetic. When you remove the field, thermal energy intervenes to randomize the alignment, and the magnetism is lost.

Electrons fill shells around the nucleus in a way that minimizes net energy. Scientists have discovered three rules that they follow when doing this, known as the Aufbrau Principle, Hund's Rule and the Pauli Exclusion Principle. Applying these rules, chemists can determine how many electrons occupy each of the subshells surrounding a nucleus.

To determine whether an element is diamagnetic or paramagnetic, it's necessary only to look at the valence electrons, which are those that occupy the outermost subshell. If the outermost subshell contains orbitals with unpaired electrons, the element is paramagnetic. Otherwise, it's diamagnetic. When writing electron configuration, the convention is to precede the valence electrons by the noble gas that precedes the element in question in the periodic table. Noble gases have completely filled electron orbitals, which is why they are inert.

By way of example, the electron configuration for magnesium (Mg) is [Ne]3s². The outermost subshell contains two electrons, but they are unpaired, so magnesium is paramagnetic. On the other hand, the electron configuration of zinc (Zn) is [Ar]4s²3d¹⁰. It has no unpaired electrons in its outer shell, so zinc is diamagnetic.

Calculation of the magnetic properties of each element can further be accomplished by writing out their electron configurations. A listing of paramagnetic elements is assembled and includes each of the following atomic elements: lithium (Li), oxygen (O), sodium (Na), magnesium (Mg), aluminum (Al), potassium (K), calcium (Ca), scandium (Sc), titanium (Ti), vanadium (V), manganese (Mn), rubidium (Rb), strontium (Sr), yttrium (Y), zirconium (Zr), niobium (Nb), molybdenum (Mb), technetium (Tc), ruthenium (Ru) (recently found to be ferromagnetic), rhodium (Rh), palladium (Pd), cesium (Cs), barium (Ba), lanthanum (La), cerium (Ce), praseodymium (Pr), neodymium (Nd), samarium (Sm), europium (Eu), terbium (Tb), dysprosium (Dy), holmium (Ho), erbium (Er), thulium (Tm), ytterbium (Yb), lutetium (Lu), hafnium (Hf), tantalum (Ta), tungsten (W), rhenium (Re), osmium (Os), iridium (Ir), platinum (Pt), thorium (Th), protactinium (Pa), uranium (U), plutonium (Pu), and americium (A).

When atoms combine to form compounds, some of those compounds can also exhibit paramagnetism for the same reason that elements do. If one or more unpaired electron exists in the compound's orbitals, the compound will be paramagnetic. Examples include molecular oxygen (O₂), iron oxide (FeO) and nitric oxide (NO). In the case of oxygen, it's possible to display this paramagnetism using a strong electromagnet. When pouring liquid oxygen between the poles of such a magnet, the oxygen will collect around the poles as it vaporizes to create a cloud of oxygen gas. the same experiment with liquid nitrogen (N₂), which is not paramagnetic, will not form such cloud.

Spontaneous magnetic ordering of paramagnetic solids upon lowering the temperature is a cooperative phenomenon, that occurs at various temperatures, depending both on the nature of the magnetic sublattice and on the strength of the exchange interaction. When spontaneous magnetic ordering occurs, the magnetic order parameter as well as the bulk magnetization of a solid undergo large changes in a relatively narrow temperature interval close to the Curie temperature and thus making it possible for a practical utilization of the Magnetocaloric Effect (MCE).

Even though it is not the absolute magnetization, but the derivative of the magnetization with respect to temperature that must be large to yield a large MCE, the 4f metals (lanthanides) and their alloys have been studied much more extensively than 3d orbital metals (Sc, Ti, V, Cr, Mn, Fe, Co, Ni, Cu and Zn) and their alloys simply because the available theoretical magnetic entropy in the former is considerably larger than in the latter. Most of the research on the MCE has been associated with either soft ferromagnetic materials ordering from ˜4 to ˜77 K for applications such as helium and hydrogen liquefaction, or materials ordering near room temperature for applications such as conventional air conditioning and refrigeration.

Paramagnetic compounds are thus determined by examining electron configurations, and in particular its unpaired electrons in the outer valence shells that bestow paramagnetic qualities. In the case of the oxygen molecule it possesses an even number of valence electrons, but they each occupy a lower energy state to minimize the overall energy state of the molecule. Instead of an electron pair in a higher orbital, there are two unpaired electrons in lower orbitals, which makes the molecule paramagnetic.

### SUMMARY

The present disclosure concerns the use of paramagnetic materials and/or compositions in inductive heating and/or magnetocaloric cooling and/or heating applications, as well as thermoelectric applications. In some aspects, this disclosure provides aluminum-based materials and/or alloys incorporating varying combinations of rare earth metals and other atomic elements.

In some aspects, the materials and/or compositions of the materials can be optimized for use in inductive heating or magnetocaloric cooling and/or heating assemblies in order to provide consistent magnetic susceptibility and high thermal conductivity properties over a wider temperature range of the materials utilized.

In other aspects, the materials can be optimized for use in a thermoelectric operation in which magnetic susceptibility, magnetization/demagnetization and Curie temperature are not considerations, and instead the materials are desired to provide the direct conversion of temperature differences to electric voltage or differences in temperature (heating/cooling) via a thermocouple with fewer limitations as to operating temperatures.

In some aspects, the present disclosure concerns the application of aluminum based materials and alloys thereof incorporating varying combinations of rare earth metals and other atomic elements or components. In some aspects, the composition of the materials is optimized for use in inductive heating or magnetocaloric cooling and/or heating assemblies and in order to provide enhanced and consistent magnetic susceptibility and thermal conductivity properties over a wider operating temperature range of the materials utilized.

As will be further described, some aspects as provided herein use aluminum (Al) as a base material (optionally at atomic percentages up to 99% or greater relative to all elements in the material) alone or in combination with secondary materials optionally selected from a group of rare earth metals including any of copper (Cu), manganese (Mn), silicon (Si), magnesium (Mg), magnesium/silicon (MgSi) and zinc (Zn). As compared to prior materials used for such systems, e.g. gadolinium (Gd) or Erbium (Er) based alloy materials which require extensive fabrication steps including the application of multiple layers, the aluminum based Pauli-paramagnetic composite materials according to the present disclosure can be cast or formed in a single step or process in order to greatly reduce fabrication time and expense. In combination, the relative cost disparity of utilizing aluminum as a base material (as opposed to gadolinium in prior applications) results in significant additional cost savings. As is known, aluminum is the third most abundant element after oxygen and silicon and the most abundant metal in the crust.

A further class of envisioned high entropy alloys of other Pauli-paramagnetic materials can further include any individual or combination of barium (Ba), cesium (Cs), cerium (Ce), lanthanum (La), lithium (Li), magnesium (Mg), manganese (Mn), potassium (K), praseodymium (Pr), samarium (Sm), sodium (Na), tin (Sn), titanium (Ti), tungsten (W) and vanadium (V) can be incorporated into an aluminum matrix composite.

A further expanded class of alloys includes a series of other paramagnetic materials that can be included as individual alloys or in combination, including aluminum based and the other Pauli-paramagnetic materials belonging to the second class described.

Optionally, materials as provided herein can be optimized for use in thermoelectric operation in which magnetic susceptibility, magnetization/demagnetization and Curie temperature are not considerations, and instead the materials are desired to provide each of electricity and heat output, and without regard to factors such as high operating temperatures. The materials when used in such systems do not necessarily rely upon the existence of magnets in order to generate eddy currents, but, instead operate on operational principles similar to those provided by thermoelectric cells (TEC's) or Peltier cells, which operate as thermoelectric heat pumps to transfer heat from one side of the cell to the other side of the cell, depending on the direction of the electrical current resulting from the cloud of electrons positioned between the respective materials.

Thermoelectric cooling or heating encompasses three separately identified effects: the Seebeck effect, Peltier effect and Thomson effect. The Peltier effect creates a heat flux at the junction of two different types of materials. A Peltier cooler, heater, or thermoelectric heat pump is a solid-state active heat pump that transfers heat from one side of the device to the other, with consumption of electrical energy, depending on the direction of the current. Such instruments, which can be referenced as a Peltier device, Peltier heat pump, solid state refrigerator and/or thermoelectric cooler, can be utilized for either heating or cooling and can also be used as a temperature controller that either heats or cools.

The primary advantages of a Peltier cooler compared to a vapor-compression refrigerator are its lack of moving parts or circulating liquid, very long life, invulnerability to leaks, small size, and flexible shape. Peltier coolers can also be used as a thermoelectric generator. When operated as a cooler, a voltage is applied across the device, and as a result, a difference in temperature will build up between the two sides. When operated as a generator, one side of the device is heated to a temperature greater than the other side, and as a result, a difference in voltage will build up between the two sides (also termed the Seebeck effect).

In some aspects, the present disclosure concerns a paramagnetic material of the formula MₐX_{b} (Formula I) wherein a is from 0.5 to 0.99 and b is 1-a, and wherein M is Al, La, Li, Mg, Na, Sn, W, V, Ca, Nd, Tb, Dy, Ho, Pd, Ge, Zn, Fe, Co, Ni, Rh, Sn, Te, Cr, Zr, Mn, Ti, or a combination thereof. The material may be configured for use in an inductive heating or magnetocaloric cooling and/or heating apparatus. Optionally, the materials may be used in a thermoelectric apparatus. In some aspects, the paramagnetic material is Pauli-paramagnetic. Optionally, M includes aluminum as a predominant. Optionally, X is one element, optionally a combination of two or more elements. Optionally, X is copper (Cu), manganese (Mn), silicon (Si), magnesium (Mg), magnesium/silicon (MgSi), zinc (Zn), or combinations thereof. In other aspects, X is selected from barium (Ba), cesium (Cs), cerium (Ce), lanthanum (La), lithium (Li), magnesium (Mg), manganese (Mn), potassium (K), praseodymium (Pr), samarium (Sm), sodium (Na), tin (Sn), titanium (Ti), tungsten (W), vanadium (V), or combinations thereof.

In some aspects, the paramagnetic material has an electrical resistivity at or greater than 50 g·mΩ/m² and/or has a thermal conductivity at or greater than 140 W/(m·K) and/or has a specific heat of equal to or less than 1200 J/(kg K) and/or has a magnetic relative permeability of equal to or less than 14 where relative permeability is the ratio of the permeability of a specific medium to the permeability of free space and/or has a mass magnetic susceptibility equal to or greater than 10⁻⁹ m³/kg.

The paramagnetic compositions may further include one or more additional alloying materials. An additional alloying material is optionally a FeCoNiCrAl-type high-entropy alloy, a pure metal, an intra-Lanthanide alloy, an aluminide, gadolinium, palladium, a gadolinium silicide, europium sulfur, a zinc alloy, ErAgGa, a 3d transition metal, a 3d metal-based alloy or intermetallic compound, a mixed Lanthanide-3d transition metal compound, a manganese-based intermetallics, an iron-based intermetallic, a cobalt-based intermetallic, a nickel-based intermetallic, an amorphous alloy, a manganite, a magneto-caloric material (MCM), or combinations thereof.

In some aspects, the present disclosure provides devices employing the materials and compositions set forth herein as a functional component. In certain aspects, a device is provided that uses one or more of the paramagnetic compositions arranged in a shape and optionally contacted with a magnet or magnetic composition. Optionally, the shape is a cylinder or ring and the magnet or magnetic composition is shaped as an exterior layer to the cylinder or ring and arranged to permit motion therebetween in a rotary, linear or eccentric manner to provide inductive heating or magneto-caloric cooling and/or heating.

In some aspects, the shape is a cylinder with the magnet or magnetic composition provided as an intermediate layer therein and arranged to allow either of a stationary or rotating arrangement of the cylinder relative to the intermediate layer and to provide for two direction thermal conductive transfer from the eddy currents created therebetween.

In some aspects, the shape is of a stacked plate array with sub-cylinders of the magnet or magnetic composition contained within each plate thereof, the stacked plate array being mounted on a shaft or spindle and adapted to be concurrently or selectively rotated therearound.

In other aspects, the shape is of a spiral with the magnet or magnetic composition arranged as an outer layer thereof with an inner end and an outer end. In further aspects, the shape is of at least one spiral shape and stacked to at least one alternate spiral in an opposing direction of the magnet or magnetic composition. The spiral shape and the alternate spiral shape may share a similar radius in width.

In other aspects, the shape is arranged as at least one layer around or above an inner core or layer comprised of the magnet or magnetic composition. In further aspects, the inner core or layer includes at least one alternating layer set of the magnet or magnetic composition and a layer of the paramagnetic composition.

In certain aspects, the shape is a stack of two or more offset petal shapes.

In some aspects, the shape is an outer layer about at least two cylinders of the magnet or magnetic composition, the cylinders being supported upon a coaxial cylindrical shaft and axially spaced apart thereon.

In some aspects, the shape is an inner cylinder operable to rotate in one direction and the magnet or magnetic composition is provided as a coaxial outer cylinder operable to rotate in a different, optionally opposite direction. An intermediate coaxial non-rotating layer may be between the inner cylinder and the outer cylinder, and the intermediate coaxial non-rotating layer includes the paramagnetic composition with magnetic components imbedded therein.

In other aspects, the shape is an inner cylinder or ring operably rotatable to and in contact with a stationary outer annular ring or layer of an alloy material, the assembly further including a battery conductively connected to the outer stationary annular ring at one or more points proximal to an interface between the inner cylinder or ring and the stationary outer annular ring.

In some aspects, movement between the shape and the magnet or magnetic composition creates a proximal temperature change increase of at least 5° C. Optionally, movement between the shape and the magnet or magnetic composition creates a proximal temperature change decrease of at least 5° C.

The present disclosure further includes uses of the materials, compositions and devices set forth herein. In some aspects, the materials, compositions and devices set forth herein can be used for heating of ambient air proximal to the device or fluidly connected thereto. Optionally, the materials, compositions and devices set forth herein can be used for heating a liquid that is either in contact with the device or fluidly connected thereto. Optionally, the materials, compositions and devices set forth herein can be used for heating a surface proximal or physically connected to the device. Optionally, the materials, compositions and devices set forth herein can be used for cooling air proximal to the device or fluidly connected thereto.

The present disclosure further includes non-magnetic applications or applications of the materials as provided herein where application of a magnetic field may be secondary or non-consequential in the operation of the apparatus. In some aspects, the present disclosure includes a Peltier cell of the paramagnetic compositions in contact with a series of alternating n and p type semiconductors. The series of semiconductors may be further connected to an electrical source connected to the paramagnetic composition.

The present disclosure further includes a material interface of the devices described herein. In some aspects, the shape is of an inner cylinder with embedded magnetic materials arranged about a central axis with a coaxial outer cylinder comprised of aluminum based and/or aluminum alloyed layers of material as provided herein containing magnetic portions. The inner cylinder and the outer cylinder may be operable to rotate about the central axis in opposing directions. In further aspects, the coaxial outer cylinder may embed an irregularly shaped interfacing magnetic layer and the inner cylinder further includes at least one irregular surface or portion thereof.

In further aspects, the present disclosure provides a material interface of the devices described herein, wherein the shape comprises a stepped inter-profile.

The present disclosure further provides a material interface of a first elongated and interiorly hollowed cylinder, being stationary mounted and constructed of a non-magnetic and conductive material with a keyed interior surface at a distal end thereof. The material interface may further include a first elongated component configured in a coaxial telescoping relationship with a keyed exterior to fit in the keyed interior of the first elongated and interiorly hollowed cylinder for linear reciprocating motion in a bi-axial direction. Such material interface can also include a conductive material shaped as a cylindrical end cap shape with an enlarged annular base that embeds an exposed core of a ferritic material that further embeds a magnetic core, the end cap operably rotatable within an open bottom at a proximal end of the first elongated and interiorly hollowed cylinder concurrent with the axial reciprocating motion of the first elongated component relative to the keyed interior at the distal end of the first elongated and interiorly hollowed cylinder.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 shows a plan view illustration of paramagnetic compositions with outer magnet material according to some aspects as provided herein.

FIG. 2 shows a further plan view illustration of paramagnetic compositions with intermediate positioned magnetic material according to a further alternate application in comparison to as shown in FIG. 1.

FIG. 3 shows a perspective view of a further component with inner and outer coaxial spaced components according to some aspects as provided herein and such as which can be employed in a magnetocaloric and/or electrothermal heat pump style application.

FIG. 4 shows a perspective illustration of a stacked plate array of paramagnetic style components including individual sub-pluralities of magnets contained within each plate.

FIG. 5 shows a plan view of a further configuration of a paramagnetic material in the form of a winding outer magnetic material containing a suitable material not limited to an inner aluminum-based core element.

FIG. 6 shows a side perspective view of a variation as compared to that shown in FIG. 5 and by which are arranged plural and alternating coiled layers of magnetic and paramagnetic materials.

FIG. 7A shows side diagrammatic illustration of one possible configuration of multiple layers of an outer aluminum paramagnetic material in combination with an inner magnet core.

FIG. 7B shows a further side diagrammatic illustration of another possible configuration of multiple layers of paramagnetic material alternating with magnetic layers and according to a further application.

FIG. 8 presents an alternate arrangement of a further aluminum-based material, such as which is shown arranged in plurality stacked and circumferentially offset petal shapes, according to a further variant of the present invention and such as which can again be employed without limitation according to any magnetocaloric and/or electrothermal heat pump.

FIG. 9 shows a further perspective illustration of a stacked array of outer paramagnetic aluminum-based materials with inner magnetic cores, such being supported upon shaft in axial spaced fashion.

FIG. 10 shows a partial view of one potential interface arrangement associated with any paramagnetic style materials utilized according to some aspects as provided herein and which includes counter rotating aluminum and aluminum/magnet embedded materials.

FIG. 11 shows a plan cutaway view of a further potential interface of such as an aluminum based paramagnetic material in combination with embedded magnetic components.

FIG. 12 presents a further envisioned interface between any type of aluminum based paramagnetic materials in combination with an arrangement of magnetic elements or layers.

FIG. 12A shows a representation of an annular shaped member with inner profile configuration associated with an interface not limited to those shown in FIGS. 10 and 12.

FIG. 13 shows a plan illustration of a combination of materials utilized in either of a magnetocaloric or electrothermal heat pump application and by which an electricity generating output can be stored within a battery.

FIG. 14 shows cross section of an interface of a magnetic core element extending diagonally relative to an outer aluminum based material construction which is in turn encased within an outer material not limited to a non-magnetized conductive material.

FIG. 15 shows opposing layers of iron and aluminum with interlacing ridges or stepped-surfacing profiles.

FIG. 16 shows opposing stepped surface profiles of a paramagnetic material or composition as set forth herein against a lower magnetic or electromagnetic layer.

### DETAILED DESCRIPTION

The present disclosure provides both the formation and application of various types of paramagnetic materials and compositions thereof, including by non-limiting representation aluminum based materials and alloys, optionally incorporating varying combinations of rare earth metals and other atomic elements. In some aspects, the present disclosure provides a composition of the Pauli-paramagnetic materials that can be used in thermoelectric, inductive, and/or magnetocaloric heating or cooling assemblies. Optionally, these assemblies can provide consistent and/or sustained magnetic susceptibility and thermal conductivity properties over a wider temperature range of the materials utilized than previously achieved. In certain aspects, the materials and/or compositions as set forth herein allow for comparable performance to gadolinium and/or erbium-based compositions but do not require the extensive, intensive and cost prohibitive layering and fabricating techniques of gadolinium and/or erbium-based compositions.

Provided are materials, compositions, devices and assemblies thereof for providing heat and/or cooling optionally with application an electrical and/or magnetic field thereto. The field may be applied by contact or proximity to a magnet or magnetic material or by connection to an electrical source, such as a direct current. The materials (e.g. aluminum and alloys thereof) may be used for providing a source of heat and/or cooling. Optionally, the materials function as a paramagnetic composition.

In some aspects, the present disclosure concerns a material of the formula MₐX_{b} (Formula I) wherein a is from 0.5 to 0.99 and b is 1-a. In some aspects a is from about 0.5 to about 0.9999, including but not limited to about 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, 0.99, and 0.999. The elements that can fulfill the place of M are optionally aluminum (Al), lanthanum (La), lithium (Li), magnesium (Mg), sodium (Na), tin (Sn), tungsten (W), vanadium (V), calcium (Ca), niobium (Nd), terbium (Tb), dysprosium (Dy), holmium (Ho), palladium (Pd), germanium (Ge), zinc (Zn), iron (Fe), cobalt (Co), nickel (Ni), rhodium (Rh), tin (Sn), tellurium (Te), chromium (Cr), zirconium (Zr), manganese (Mn), titanium (Ti), or a combination thereof. In some aspects, M is predominantly aluminum where predominantly is defined as at a level greater than all other elements in the material, optionally at or greater than 50 atomic or molar percent. The material may be configured for use in a thermoelectric, inductive, magnetocaloric cooling and/or heating apparatus.

In some aspects, the material of formula I is Pauli-paramagnetic. Optionally, the material is suitable for providing or creating a change in temperature of a fluid (e.g gas or liquid) or a solid proximal to or fluidly or physically connected to or contacting the material. In some aspects, the material has a specific heat capacity of about 1200 J/(kg K) or lower. Heat capacity or thermal capacity refers to a physical property of matter, defined as the amount of heat to be supplied to a given mass of a material to produce a unit change in its temperature.

In some aspects, the material has an electrical resistivity (with respect to material density) of about 50 (g mΩ)/m² or greater. The electrical resistance of an object refers to a measure of its opposition to the flow of electric current. However, resistance is extensive rather than a bulk property, meaning that it may also depend on the size and shape of the object.

In some aspects, the material has a thermal conductivity of about 140 W/(m K) or greater. The thermal conductivity of a material refers to a measure of its ability to conduct heat. Thermal conductivity is commonly denoted by k, λ, or κ. Heat transfer may occur at a lower rate in materials of low thermal conductivity than in materials of high thermal conductivity. For instance, metals typically have high thermal conductivity and are very efficient at conducting heat, while the opposite is true for insulating materials.

In some aspects, the material has a level of magnetic relative permeability or electromagnetism index (SI) of 14 or lower. Relative permeability refers to a ratio of the permeability of a specific medium to the permeability of free space. Permeability may refer to the measure of the resistance of a material against the formation of a magnetic field, otherwise known as distributed inductance in transmission line theory. Hence, it is the degree of magnetization that a material obtains in response to an applied magnetic field. Permeability is typically represented by the (italicized) Greek letter μ. The index refers to the Henries/meter standard μ₀ for the magnetic constraint or permeability of free space proportional to the dimensionless fine-structure constant.

In some aspects, the material has a mass magnetic susceptibility (χmass) of 10⁻⁹ m³/kg or greater.

In further aspects, the material has small to no hysteresis, low anisotropy and/or a large ΔS or change in entropy in a magnetic field and/or ΔT or change in adiabatic temperature when exposed to a magnetic field.

Other materials for providing temperature changes through a magnetocaloric effect such as gadolinium (Gd) or Erbium (Er) based alloy materials are known to require extensive fabrication steps including the application of multiple layers. In contrast, the Pauli-paramagnetic compositions and materials of the present disclosure can be cast or formed in a single step or process or otherwise produced in a much more simplified fashion in order to greatly reduce fabrication time and expense, while still providing a comparable level of change in entropy (or J/(kg)(K)). In combination, the relative effectiveness to cost disparity ratio in utilizing aluminum as a base material (as an example) provides a significant advantage. Furthermore, some gadolinium ions occurring in water-soluble salts are toxic, whereas aluminum can be well tolerated.

In certain aspects, the present disclosure uses in the devices or portions thereof materials other than gadolinium and erbium. In some aspects, the compositions contain from zero or about zero to about 10% by atomic weight of gadolinium and/or erbium, including or less than 0.1, 0.2, 0.3, 0.4, 0.5, 0.6, 0.7, 0.8, 0.9, 1, 2, 3, 4, 5, 6, 7, 8, and 9 atomic or molar percent. In some aspects, the materials and/or compositions of the present disclosure exclude gadolinium and/or erbium. While these materials have previously demonstrated an applicability to perform in magnetocaloric applications, they provide disadvantages in both preparing a device or assembly efficiently and/or effectively, such as through low availability and difficulty in casting or preparing as a solid.

In some aspects, the present disclosure provides compositions of the material described herein. In some aspects, the compositions of the a material of the formula MₐX_{b} (Formula I) includes M as Al and X being selected from the group of copper (Cu), manganese (Mn), silicon (Si), magnesium (Mg), magnesium/silicon (MgSi), zinc (Zn), or combinations thereof. In other aspects, X can be selected from the group of barium (Ba), cesium (Cs), cerium (Ce), lanthanum (La), lithium (Li), magnesium (Mg), manganese (Mn), potassium (K), praseodymium (Pr), samarium (Sm), sodium (Na), tin (Sn), titanium (Ti), tungsten (W), vanadium (V), or combinations thereof, optionally where a is 0.5 or greater, optionally 0.9 or greater, optionally 0.99 or greater.

Optionally, the compositions may further include a FeCoNiCrAl-type high-entropy alloy, a pure metal, an intra-Lanthanide alloy, an aluminide, gadolinium, palladium, a gadolinium silicide, europium sulfur, a zinc alloy, ErAgGa, a 3d transition metal, a 3d metal-based alloy and intermetallic compound, a mixed Lanthanide-3d transition metal compound, a manganese-based intermetallics, an iron-based intermetallic, a cobalt-based intermetallic, a nickel-based intermetallic, an amorphous alloy, a manganite, a magneto-caloric material (MCM), or combinations thereof.

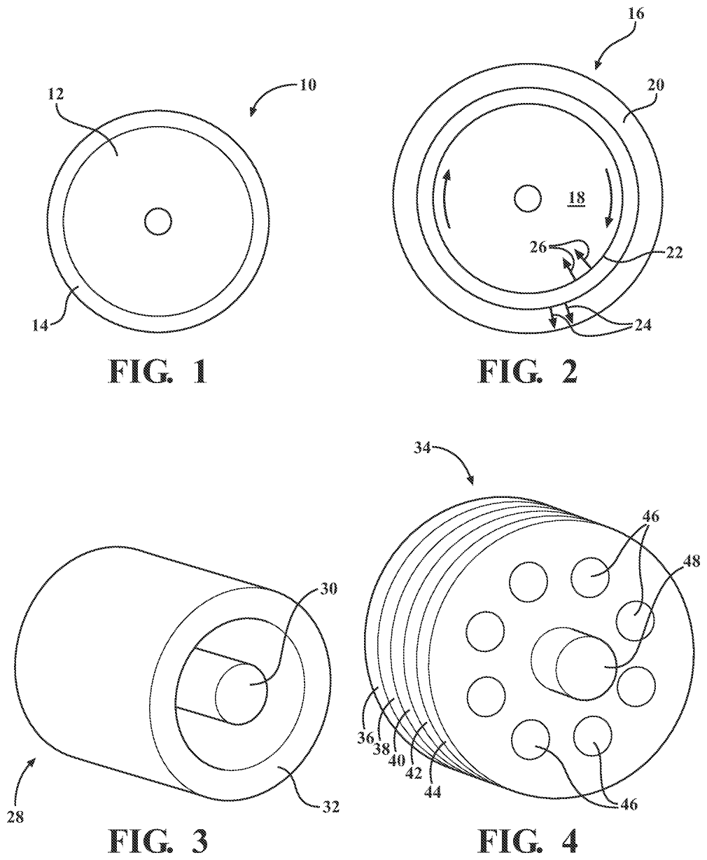

As is described herein, the paramagnetic compositions and materials described can optionally be used and/or applied in thermoelectric operations in which the materials are desired to operate along the principals of thermoelectric cells in order to provide each of electricity and heat output with fewer limitations as to operating temperatures than prior systems. Furthermore, the examples of material constructions and interfacing arrangements depicted in FIGS. 1-16, are intended as being non-limiting in regards to potential structural applications of the materials and, with additional reference to potential alternate variants, the present materials can be reconfigured as any of a magnetocaloric fluid heat pump, active magnetic regenerator, magnetic/magnetocaloric refrigerator, or magnetic/electromagnetic air conditioner, among other configurations.

In some aspects, the present disclosure concerns application of the Pauli-paramagnetic materials and/or compositions in either of a thermoelectric, inductive or magnetocaloric cooling and/or heating system or device. A material used as a portion of or whole of an apparatus as provided herein includes aluminum (Al) as a base material, which can be provided at percentages up to 99% or greater by atomic weight percent alone or in combination with secondary elements such as any of rare earth metals, copper (Cu), manganese (Mn), silicon (Si), magnesium (Mg), magnesium/silicon (MgSi) and zinc (Zn). Magnetocaloric materials (MCM) of the present disclosure can include any of pure aluminum, or aluminum alloys (e.g. Al₁₋ₓMnₓ where x is from 0.01 to 0.6, or any value or range therebetween) and related alloys. The addition of alloying elements to aluminum is the principal method used to produce a selection of different materials that can be used in a wide-assortment of structural applications. The major (seven) designated aluminum alloy series used for wrought alloys, including the main alloying elements used for producing each of the alloy series, are presented in Table 1.

TABLE 1

| Series | Primary Alloying Element |
|---|---|
| 1xxx | Negligible-99.0% pure Al and above |
| 2xxx | Cu |
| 3xxx | Mn |
| 4xxx | Si |
| 5xxx | Mg |
| 6xxx | MgSi |
| 7xxx | Zn |

The principal effects of alloying elements in aluminum are further described as follows. For copper alloys (2xxx), the aluminum-copper alloys optionally contain between 2 to 10 at % copper, with optional smaller additions of other elements. The copper provides substantial increases in strength and facilitates precipitation hardening. The introduction of copper to aluminum can also reduce ductility and corrosion resistance. The susceptibility to solidification cracking of aluminum-copper alloys is increased; consequently, some of these alloys can be the most challenging aluminum alloys to weld. These alloys include some of the highest strength heat treatable aluminum alloys. The most common applications for the 2xxx series alloys are aerospace, military vehicles and rocket fins.

With manganese (Mn) alloys (3xxx), the addition of manganese to aluminum increases strength somewhat through solution strengthening and improves strain hardening while not appreciably reducing ductility or corrosion resistance. These are moderate strength non-heat-treatable materials that retain strength at elevated temperatures and are seldom used for major structural applications. The most common applications for the 3xxx series alloys are cooking utensils, radiators, air conditioning condensers, evaporators, heat exchangers and associated piping systems.

With silicon alloys (Si) (4xxx), the addition of silicon to aluminum reduces melting temperature and improves fluidity. Silicon alone in aluminum produces a non-heat-treatable alloy; however, in combination with magnesium it produces a precipitation hardening heat-treatable alloy. Consequently, there are both heat-treatable and non-heat-treatable alloys within the 4xxx series. Silicon additions to aluminum are commonly used for the manufacturing of castings. The most common applications for the 4xxx series alloys are filler wires for fusion welding and brazing of aluminum.

With magnesium (Mg) alloys (5xxx), the addition of magnesium to aluminum increases strength through solid solution strengthening and improves their strain hardening ability. These alloys are the highest strength non-heat-treatable aluminum alloys. The 5xxx series alloys are produced mainly as sheet and plate and only occasionally as extrusions. The reason for this is that these alloys strain harden quickly and, are, therefore difficult and expensive to extrude. Some common applications for the 5xxx series alloys are truck and train bodies, buildings, armored vehicles, ship and boat building, chemical tankers, pressure vessels and cryogenic tanks.

With alloys that include magnesium and silicon (Mg₂Si) (6xxx), the addition of magnesium and silicon to aluminum produces the compound magnesium-silicide (Mg₂Si). The formation of this compound provides the 6xxx series their heat-treatability. The 6xxx series alloys are easily and economically extruded and for this reason are most often found in an extensive selection of extruded shapes. These alloys form an important complementary system with the 5xxx series alloy. The 5xxx series alloy used in the form of plate and the 6xxx are often joined to the plate in some extruded form. Some of the common applications for the 6xxx series alloys are handrails, drive shafts, automotive frame sections, bicycle frames, tubular lawn furniture, scaffolding, stiffeners and braces used on trucks, boats and many other structural fabrications.

With zinc (Zn) alloys (7xxx), the addition of zinc to aluminum (in conjunction with some other elements, primarily magnesium and/or copper) produces heat-treatable aluminum alloys of the highest strength. The zinc substantially increases strength and permits precipitation hardening. Some of these alloys can be susceptible to stress corrosion cracking and for this reason are not usually fusion welded. Other alloys within this series are often fusion welded with excellent results. Some of the common applications of the 7xxx series alloys are aerospace, armored vehicles, baseball bats and bicycle frames.

Additional elements can be included with the alloys. With iron (Fe) alloys, iron is the most common impurity found in aluminum and is intentionally added to some pure (1xxx series) alloys to provide a slight increase in strength. Chromium (Cr) alloys help to control grain structure, to prevent grain growth in aluminum-magnesium alloys, and to prevent recrystallization in aluminum-magnesium-silicon or aluminum-magnesium-zinc alloys during heat treatment. Chromium will also reduce stress corrosion susceptibility and improves toughness. Nickel (Ni) added to aluminum-copper and to aluminum-silicon alloys helps to improve hardness and strength at elevated temperatures and to reduce the coefficient of expansion. Titanium (Ti) is added to aluminum primarily as a grain refiner. The grain refining effect of titanium is enhanced if boron is present in the melt or if it is added as a master alloy containing boron largely combined as TiB₂. Titanium is a common addition to aluminum weld filler wire as it refines the weld structure and helps to prevent weld cracking. Zirconium (Zr) can be added to aluminum to form a fine precipitate of intermetallic particles that inhibit recrystallization. Lithium (Li) can substantially increase strength and, Young's modulus, provide precipitation hardening and decreases density. Lead (Pb) and Bismuth (Bi) can be added to aluminum to assist in chip formation and improve machinability. These free machining alloys are often not weldable because the lead and bismuth produce low melting constituents and can produce poor mechanical properties and/or high crack sensitivity on solidification.

As is understood in the art, there are many aluminum industrial alloys available, including over 400 currently registered wrought alloys and over 200 currently registered casting alloys that may be used as provided herein. Alloys typically maintain about 85% aluminum by atomic percent or greater, including about 86, 87, 88, 89, 90, 91, 92, 93, 94, 95, 96, 97, 98, and 99 percent by atomic weight, with the alloying elements typically of about 15 percent by atomic weight or lower, including about 14, 13, 12, 11, 10, 9, 7, 7, 6, 5, 4, 3, 2, and 1 percent by atomic percent. In certain aspects, the alloying element can be less than 1 percent by atomic percent of the alloy, including about 0.01, 0.02, 0.03, 0.04, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, and 0.99.

Wrought alloys are typically defined by a four-digit number, where the first digit indicates the major alloying elements, the second—if different from 0—indicates a variation of the alloy, and the third and fourth digits identify the specific alloy in the series. For example, for alloy 3105, the number 3 indicates the alloy is in the manganese series, 1 indicates the first modification of alloy 3005, and finally 05 identifies it in the 3000 series. Table 2 presents a summary of the 8 current series.

TABLE 2

| | |
|---|---|
| 1000 | Essentially pure aluminum with a minimum 99% aluminum content |
| series | by weight and can be work hardened. |
| 2000 | Alloyed with copper, can be precipitation hardened to strengths |
| series | comparable to steel. Formerly referred to as duralumin, they were |
| | once the most common aerospace alloys, but were susceptible to |
| | stress corrosion cracking and are increasingly replaced by 7000 |
| | series in new designs. |
| 3000 | Alloyed with manganese and can be work hardened. |
| series | |
| 4000 | Alloyed with silicon. Variations of aluminum-silicon alloys |
| series | intended for casting (and therefore not included in 4000 series) |
| | are also known as silumin. |
| 5000 | Alloyed with magnesium, and offer superb corrosion resistance, |
| series | making them suitable for marine applications. Also, 5083 alloy has |
| | the highest strength of not heat-treated alloys. Most 5000 series |
| | alloys include manganese as well. |
| 6000 | Alloyed with magnesium and silicon. They are easy to machine, |
| series | are weldable, and can be precipitation hardened, but not to the |
| | high strengths that 2000 and 7000 can reach. 6061 alloy is one |
| | of the most commonly used general-purpose aluminum alloys. |
| 7000 | Alloyed with zinc, and can be precipitation hardened to the highest |
| series | strengths of any aluminum alloy (ultimate tensile strength up to |
| | 700 MPa for the 7068 alloy). Most 7000 series alloys include |
| | magnesium and copper as well. |
| 8000 | Alloyed with other elements which are not covered by other series. |
| series | Aluminum-lithium alloys are an example. |

Cast alloys are identified by a nomenclature similar to that of wrought alloys and include the second two digits reveal the minimum percentage of aluminum, e.g. 150.x correspond to a minimum of 99.50% aluminum. The digit after the decimal point takes a value of 0 or 1, denoting casting and ingot respectively. The main alloying elements in the AA system are presented in Table 3.

TABLE 3

| | |
|---|---|
| 1xx.x series | Minimum 99% aluminum |
| 2xx.x series | Copper |
| 3xx.x series | Manganese |
| 4xx.x series | Silicon |
| 5xx.x series | Magnesium |
| 6xx.x series | Magnesium and Silicon |
| 7xx.x series | Zinc |
| 8xx.x series | Other elements |
| 9xx.x series | Unused |

In addition to cast and wrought alloys, named alloys, such as the following, are also contemplated for inclusion with the compositions disclosed in Table 4.

TABLE 4

| | |
|---|---|
| Alferium | an aluminum-iron alloy developed by Schneider, used for |
| | aircraft manufacture by Société pour la Construction |
| | d'Avions Métallique “Aviméta” |
| Alclad | aluminum sheet formed from high-purity aluminum surface |
| | layers bonded to high strength aluminium alloy core |
| | material |
| Birmabright | a product of The Birmetals Company, basically equivalent |
| (aluminium, | to 5251 |
| magnesium) | |
| Duralumin | copper, aluminum |
| Hindalium | aluminum, magnesium, manganese, silicon) product of |
| | Hindustan Aluminum Corporation Ltd, made in 16ga rolled |
| | sheets for cookware |
| Pandalloy | Pratt&Whitney proprietary alloy, supposedly having high |
| | strength and superior high temperature performance. |
| Magnalium | |
| Magnox | magnesium, aluminum |
| Silumin | aluminum, silicon |
| Titanal | aluminum, zinc, magnesium, copper, zirconium- a product |
| | of Austria Metall AG. Commonly used in high performance |
| | sports products, particularly snowboards and skis |
| Y alloy, | pre-war nickel-aluminum alloys, used in aerospace and |
| Hiduminium, | engine pistons for their ability to retain strength at |
| R.R. alloys | elevated temperature. These are replaced nowadays by |
| | higher-performing iron-aluminum alloys like 8009 which |
| | are capable to operate with low creep up to 300 C. |

A further class of high entropy alloys of other Pauli-paramagnetic materials that can be utilized in the paramagnetic compositions of the present disclosure include any individual or combination of M from formula I alloyed with barium (Ba), cesium (Cs), cerium (Ce), lanthanum (La), lithium (Li), magnesium (Mg), manganese (Mn), potassium (K), praseodymium (Pr), samarium (Sm), sodium (Na), tin (Sn), titanium (Ti), tungsten (W) vanadium (V), or any combination thereof and that can be incorporated into an aluminum matrix composite.

A further class of alloys applicable for inclusion as part of the paramagnetic compositions of the present disclosure includes, but is not limited to, any aluminum or alloy thereof discussed herein further complexed with the molecules presented in Table 5.

TABLE 5

| | |
|---|---|
| FeCoNiCrAl- | FeCoNiCrAl; FeCoNiCr_{1-X}Al_{1+X}; and, FeCoNi_{1+X}Cr_{1-X}Al |
| type high- | |
| entropy alloys | |
| Pure Metals | Nd; Gd; Tb; Dy; Ho; Er |
| Intra- | Gd₁₋ₓTbₓ; Gd₁₋ₓDyₓ; Gd₁₋ₓHoₓ; and, Gd₁₋ₓErₓ |
| Lanthanide | |
| Alloys | |
| Aluminides | RT₄Al₈ (R = Sc, Y, La, Lu; T = Fe, Mn, Cr) compounds; Gd₃Al₂; Er₃Al; Er₃AlC; |
| | Er₃AlCₓ; DyAl₂; HoAl₂; (Gd_{0.14}Er_{0.86})Al₂; (Dy_{0.5}H_{0.5})Al₂; (Dy_{0.1}Er_{0.9})Al₂; |
| | (Dy₁₋ₓErₓ)Al₂; (Dy_{0.5}Ho_{0.5})Al₂; and, (Dy₁₋ₓErₓ)Al₂ |
| Gadolinium | GdPd |
| Palladium | |
| Gadolinium | Gd₅(SiₓGe₁₋ₓ)₄; Gd₅Si₂Ge₂; and, Gd₅Si₄—Gd₅Ge₄ |
| Silicides | |
| Europium | EuS |
| Sulfur | |
| Zinc Alloys | Gd_{0.75}Zn_{0.25} |
| Erbium Silver | ErAgGa |
| Gallium | |
| 3d Metals | Fe; Co; and, Ni |
| 3d Metal-Based | Fe_{0.9357}Si_{0.064}; Mn_{0.225}Cu_{0.775}; Ni₂(Mn₁₋ₓVₓ)Sn; Ni₂(Mn₁₋ₓNbₓ)Sn; |
| Alloys and | Mn_{3-y-x}Cr_{y}AlC₁₊ₓ; (Hf_{0.83}Ta_{0.17})Fe₂₊ₓ; FeRh; Cr₃Te₄; Mn(As₁₋ₓPₓ); |
| Intermetallic | Ni₂(Mn₁₋ₓMₓ)Sn; Mn_{3-y-z}Cr_{y}AlC_{1+z}; Ni₂(Mn₁₋ₓVₓ)Sn; Mn_{3-y-z}Cr_{y}AlC_{1+z}; |
| Compounds | (Hf_{0.83}Ta_{0.17})Fe₂₊ₓ; Fe₅₁Rh₄₉; Fe_{50.4}Rh_{49.6}; and, Cr₃Te₄ |
| Manganese-Based | NdMn₂SiZ |
| Intermetallics | |
| Iron-Based | YFe₂; ErFe₂; YFe₃; HoFe₃; TbFe₂; and, (TbₓY₁₋ₓ)Fe₂ |
| Intermetallics | |
| Cobalt-Based | DyCo₂; HoCo₂; and, ErCo₂ |
| Intermetallics | |
| Nickel-Based | Er₃Ni; GdNi; RNi₂ phase with R = Gd, Tb, Dy, Ho, Er and Gd_{0.1}Dy_{0.9}; RAlNi for |
| Intermetallics | R = Gd, Dy and Er; and, (GdₓEr₁₋ₓ)AlNi |
| Amorphous | Gd_{0.7}Fe_{0.3}; Gd_{0.7}Fe_{0.12}Ni_{0.18}; Gd_{0.65}Co_{0.35}; Gd_{0.7}Cu_{0.3}; Dy_{0.7}Fe_{0.3}; |
| Alloys | Dy_{0.7}Fe_{0.12}Ni_{0.18}; Dy_{0.7}Ni_{0.3}; Dy_{0.7}Cu_{0.3}; Dy_{0.7}Zr_{0.3}; Dy_{0.3}Zr_{0.7}; Er_{0.7}Fe_{0.3}; and, |
| | Fe_{0.05}Co_{0.70}Si_{0.15}B_{0.1} |
| Manganites | lanthanum-manganese perovskite compounds (La₁₋ₓMₓ)MnO₃, where M = Li, |
| | Na, K, Ca, Sr, Ba, and Y |
| Other MCMs | MnₓFe₂₋ₓ(P_{1-y}Ge_{y}); EuTiO₃; Eu₄PdMg; GdCd₁₋ₓRuₓ; DyNi₂B₂C; |
| | Dy_{0.9}Tm_{0.1}Ni₂B₂C; Dy₁₋ₓHoₓNi₂B₂C; Co_{0.5}Pt_{0.5}; Ni_{0.5}Co_{0.5}; Co_{0.7}Pt_{0.3}; Mn_{0.3}Pd_{0.7}; |
| | AgMg_{0.5}Zn_{0.5}; Co_{0.92}Fe; Co_{0.8}Os_{0.2}; Co_{0.8}Ru_{0.2}; Mg_{0.25}Ag_{0.75}; Pt_{0.36}Fe_{0.64}; |
| | Co_{0.9}Cr_{0.1}; Co_{0.8}Re_{0.2}; Cu₂FeSn; Co₂GeZn; Mn_{0.5}Pt_{0.5}; Co_{0.8}W_{0.2}; Rh_{0.7}Mn_{0.3}; |
| | CoRe; Co_{0.75}V_{0.25}; Co_{0.8}Ga_{0.2}; Mn_{0.5}Fe_{0.5}; Li_{0.4}Au_{0.6}; MnPd₃; MgAg₃; Au₃Li; |
| | Ni₃Ga; CrRh₃; TaRh₃; Mn₃Pt; Mn₃Rh; Co_{0.7}V_{3.3}; Cr_{0.7}Co_{0.3}; Cr_{0.8}Ni_{0.2}; La_{0.8}Mg_{0.2}; |
| | Mg_{0.7}Li_{0.3}; Li_{0.3}Mg_{0.7}; Li_{0.5}Mg_{0.5}; Li_{0.9}Mg_{0.1}; MnPd; CoFe; MnRh; MgAg; MgAu; |
| | NiAl; CoGa; LiAu; MgLa; Ni—Mn—Z; Ni₂MnGa; 0.75La0.6Ca0.4MnO₃/ |
| | 0.25La0.6Sr0.4MnO₃ nanocomposite manganite; Ba₂₋ₓSrₓFeMoO₆; and, |
| | MnₓFe₂₋ₓ(P_{1-y}Ge_{y}) |

In some aspects, provided are materials and compositions as set forth herein in a solid-state cell for providing heating and/or cooling. The materials and compositions of the present disclosure may be placed in contact with a series of alternating p and n type semiconductors to relay or conduct a heat change caused by application of an electric current through the alternating n and p type semiconductors effectively as a Peltier cell. The n and p type semiconductors can be aligned alternating pillars that are in contact with the materials and/or compositions of the present disclosure at one or both ends of each pillar, such that the n and p type semiconductors are sandwiched therebetween. Application of a direct current allows for the movement of heat from one side of the pillars to the other.

In some aspects of the present disclosure, a magnetocaloric effect can propagated by the materials and/or compositions of the present disclosure. Such can be achieved when the materials and/or compositions disclosed herein are placed within a magnetic field and/or a moving or varying magnetic field. A magnetic field may be applied to the materials and/or compositions by placing such in proximity to a magnet or magnetic material. Such are magnets and magnetic materials are understood in the art. By way of example, such may include electromagnets, ferritic magnets, neodymium magnets, samarium cobalt magnets, aluminum nickel cobalt magnets, rare earth magnets, electromagnets, as well as metals and alloys of iron, nickel, cobalt, awaruite, wairauite, feroxyhyte, gregite, pyrrhotite, magnesioferrite, trevorite, jacobsite, maghemite, and magnetite.

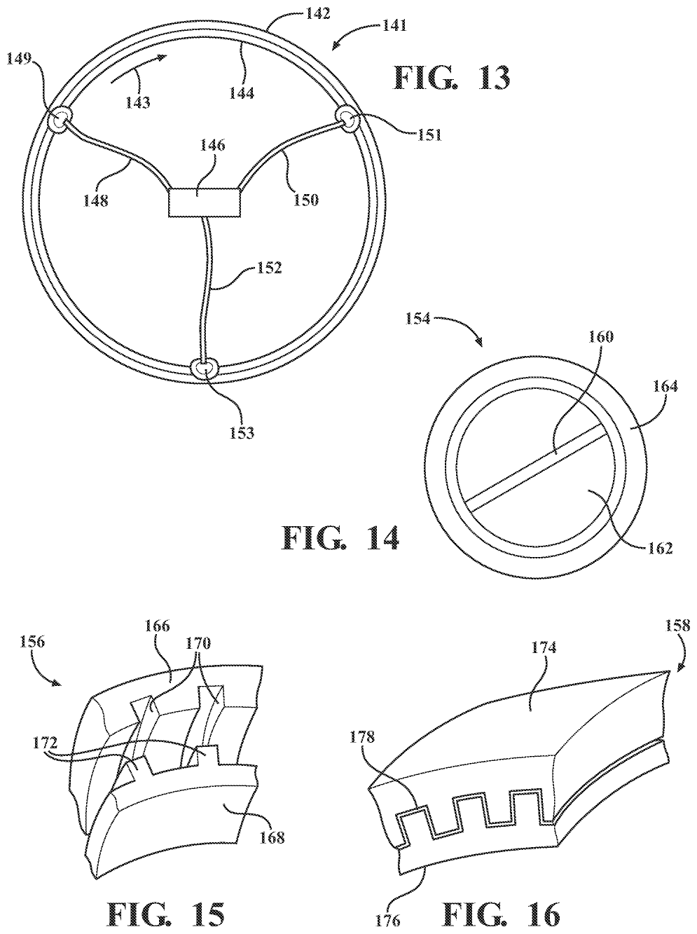

FIGS. 1-16 below present a variety of exemplary and non-limiting device illustrations concerning application of the described materials and compositions. The materials and/or compositions can be directed to a first application wherein they are optimized for use in inductive heating or magnetocaloric cooling and/or heating assemblies. In addition to the devices as described herein, the materials of this disclosure may be applied in systems or portions thereof as described in US Publications 2020/0037404, 2020/0037403, 2020/0068668, 2020/0068667, and U.S. patent application Ser. Nos. 17/021,519, 17/066,638, 17/082,106, and 17/095,817, among others. Such applications can provide consistent magnetic susceptibility and thermal conductivity properties over a wider operating temperature range of the materials utilized. The materials and compositions may further be utilized in a second application (see, e.g., FIGS. 2 and 13) in which the materials are optimized for use in a thermoelectric operation (in which magnetic susceptibility and Curie point temperature are not considerations), where the materials are desired to produce each of electricity and heat output with reduced limitations as to operating temperatures relative to prior devices.

With reference to FIG. 1, a plan view illustration is generally shown 10 of an aluminum based paramagnetic composition 12 (such as which can without limitation be selected from any of the above-referenced compositions described herein) with an outer (rare earth based or other) magnet material 14 according to an application of the present invention. As will be further described with the various further illustrations, relative motion, including any of rotary, linear or eccentric, between the conductive and magnetized material is accomplished according to any inductive heating or magnetocaloric cooling and/or heating application.

Alternatively, the magnetic/magnetized materials disclosed and illustrated herein are also envisioned to provide any movable or stationary interfacing relationship with an opposing material according to an electrothermal heat pump application. In such an application, the desire of such a “Peltier cell” type effect is to provide either of heat or electricity at elevated operating temperatures beyond the normal Curie point temperatures of the MCM materials utilized.

FIG. 2 is a further plan view illustration, generally at 16, of an aluminum based paramagnetic compound, see inner 18 and outer 20 concentric layers, with intermediate positioned magnetic material layer 22 according to a further alternate application in comparison to as shown in FIG. 1. The construction of the variant 16 envisions either of a stationary or rotating arrangement of the inner aluminum based paramagnetic material 18 relative the intermediate magnetized layer 22 or outer aluminum material 20, with the illustrated interface further optimizing two direction thermal conductive transfer resulting from the eddy currents created between the magnetized and conductive materials, and as depicted by both outwardly referenced arrows 24 and inwardly as further referenced by arrows 26.

FIG. 3 is a perspective view, at 28, of a further material, again including but not exclusively limited to an aluminum-based component with inner 30 and outer 32 coaxial spaced components according to a further variant of the present invention and such as which can be employed in a magnetocaloric and/or an electrothermal heat pump style application according to the afore-mentioned description.

FIG. 4 is a perspective illustration 34 of a stacked plate array of paramagnetic style components, see at 36, 38, 40, 42 and 44 including individual sub-pluralities of magnets (see at 46 for outermost plate 44) which are contained within each plate. The plates are further shown mounted on a shaft or spindle, see at 48, and can be concurrently or selectively rotated according to either of an inductive heating or magnetocaloric cooling and/or heating application, such further remaining stationary according to an electrothermal heat pump application.

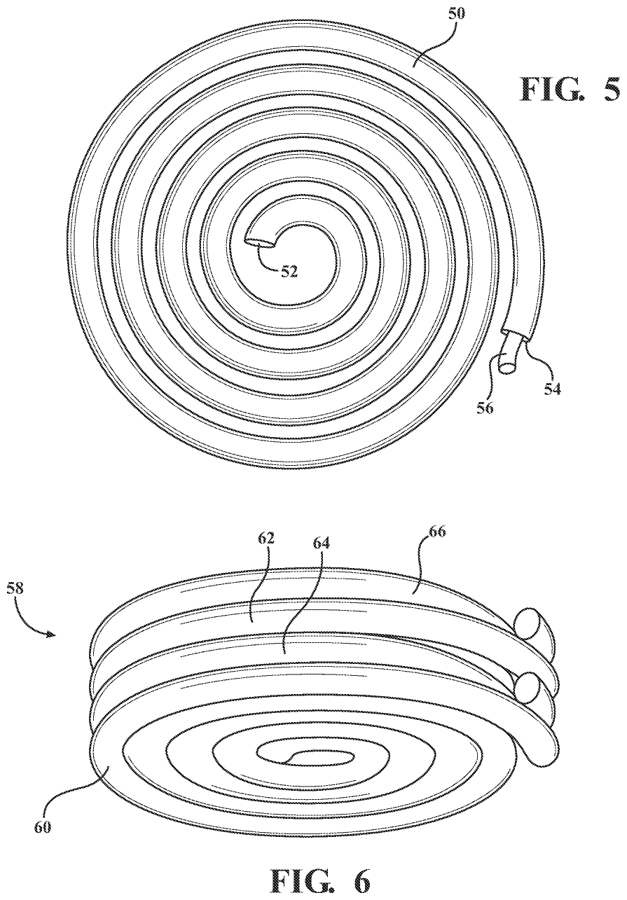

FIG. 5 is a planar view of a further configuration of a paramagnetic material in the form of a spiral winding outer magnetic body of material 50, between an inner end 52 and outermost end 54. The spiral magnet body can include an interior seating a material, at 56, and such as including an inner aluminum-based core element or alloyed composition thereof according to any of the embodiments described herein.

FIG. 6 is a side perspective view, at 58, of a variation of the spiral winding component, as compared to that shown in FIG. 5, and by which are arranged plural and alternating coiled layers of magnetic 60 and 62 and alternating aluminum paramagnetic MCM 64 and 66 materials.

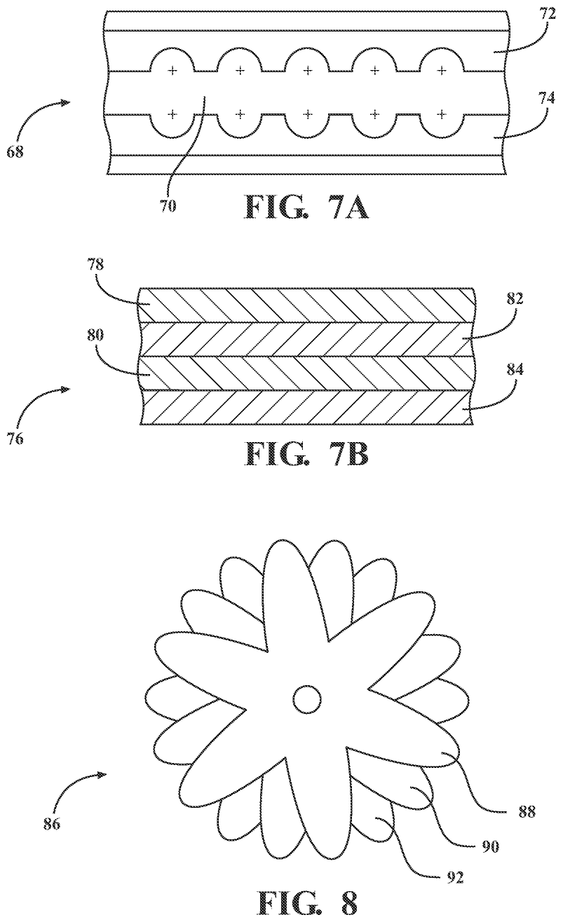

FIG. 7A is side diagrammatic illustration 68 of one possible configuration of multiple layers of outer (such as again aluminum by non-limiting example) based paramagnetic materials (see at 72 and 74) in combination with an inner magnet core (at 70). FIG. 7B is a further side diagrammatic illustration 76 of another possible configuration of multiple layers of aluminum based paramagnetic materials 78 and 80 alternating with magnetic layers 82 and 84 according to a further application.

FIG. 8 presents an alternate arrangement 86 of a further aluminum-based material, such as which is shown arranged in plurality stacked and circumferentially offset petal shapes 88, 90 and 92, according to a further variant of the present invention and such as which can again be employed without limitation according to any magnetocaloric and/or electrothermal heat pump application.

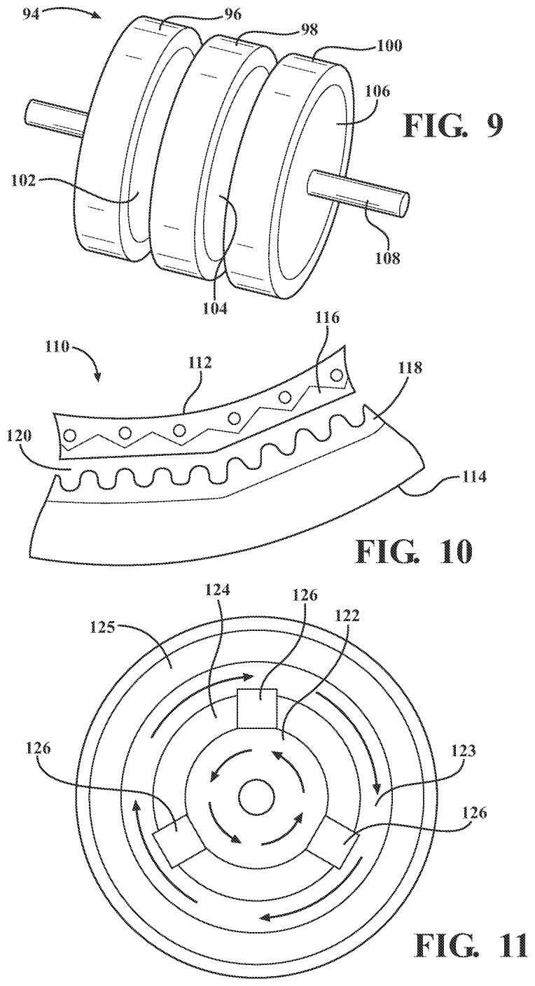

FIG. 9 is a further perspective illustration 94 of a stacked array of outer paramagnetic aluminum-based materials 96, 98, 100 with inner magnetic cores 102, 104, 106, such being supported upon a shaft 108 in axial spaced fashion.

FIG. 10 is a partial view 110 of one potential interface arrangement associated with any paramagnetic style materials utilized according to the present invention and which includes counter rotating aluminum and aluminum/magnet embedded materials, these depicted by outer aluminum based and/or alloyed layers 112 and 114 which contain magnetic portions or the like, and as further depicted at 116 and 118. The layer 114 can further include an outermost aluminum MCM surfacing layer 120 which embeds the lower magnetic layer 118, with the opposing and upper interfacing magnetic layer 116 exhibiting a likewise irregular (e.g. angled or sloping) surface in order to optimize the desired properties at the interface according to either of the magnetic induction, magnetocaloric heating/cooling or electrothermal heat pump applications envisioned in the present invention.

FIG. 11 is a plan cutaway view of a further potential assembly including an interface of an aluminum or other paramagnetic material with one or more magnetic compounds or layers. In the illustration depicted, a paramagnetic layer 122 is provided rotating in a first direction, with a further outer coaxial magnetic/electromagnetic layer 123 rotating in a counter direction. A pair of inner 124 and outer 125 stationary layers are further depicted in alternating placement relative to the counter-rotating layers 122 and 123 and, in combination with embedded magnetic components 126 integrated into a further stationary paramagnetic layer 124, for achieving either of magnetocaloric heating/cooling in one application as well as operating as a thermo-electric heat pump by virtue of counter rotating respective conductive materials (again not limited to such as Al or Cu) in a further non-magnetic application.

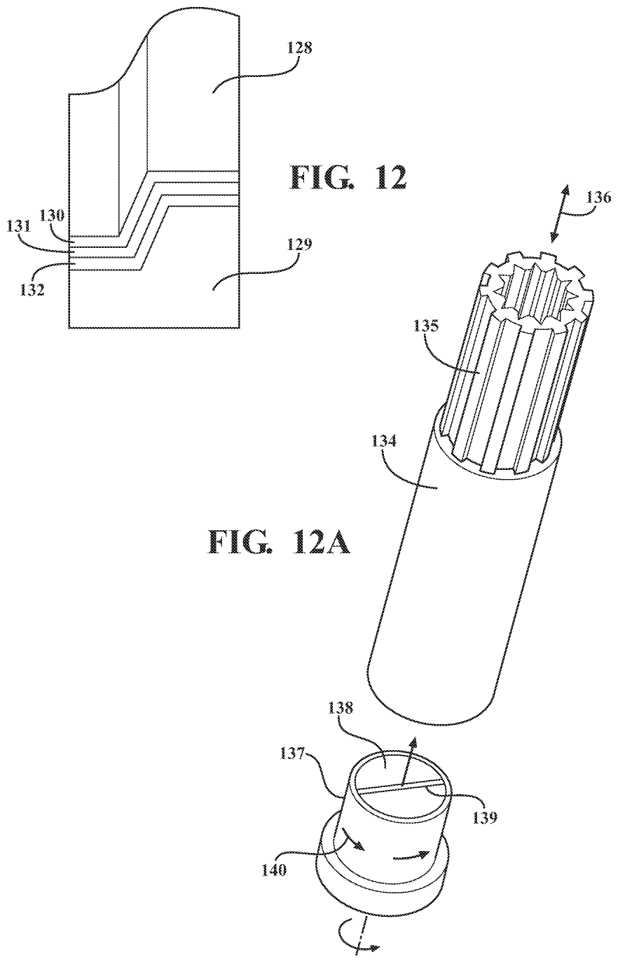

FIG. 12 presents a further envisioned interface between any type of aluminum based paramagnetic materials in combination with an arrangement of magnetic elements or layers. This is depicted by aluminum paramagnetic layers 128 and 129 which can exhibit a stepped inter-profile. One or more magnetic layers can be configured along either the stepped profile (and shown by multiple layers 130, 131 and 132). Without limitation, the interface profile shown can include an optimal thermal transfer profile such that the profiles of either of FIG. 10 or 12 can be integrated into an inner profile configuration of an annular shaped member as will now be further described in reference to FIG. 12A.

FIG. 12A as shown depicts a first elongated and interiorly hollowed cylinder 134, such being stationary mounted and constructed of a non-magnetized and conductive material not limited to the classes of the materials described herein. A first elongated component 135 is configured in coaxial telescoping relationship with a keyed interior of the stationary tubular or cylindrical component for linearly reciprocating motion in a bi-axial direction as referenced by arrow 136.

A second conductive material is shaped in a cylindrical end cap shape 137 with an enlarged annular base and which embeds an exposed core of a suitable material 138 (by non-limiting example possibly including a ferrite material such a iron). A further magnetic core is depicted at 139 which can be embedded or potted within the iron 138. The second end cap portion 137 is further rotated within the open bottom of the stationary member 134 as referenced by directional arrow 140, such occurring concurrent with the axial reciprocating motion of the inner keyed and elongated cylindrical component 136 relative to the upper interior of the hollow non-magnetized conductive material 134. In this fashion, the illustrated design can provide any combination of paramagnetic and/or thermo-electric applications.

FIG. 13 presents a plan illustration 141 of a combination of materials utilized in either of a magnetocaloric or electrothermal heat pump application and by which an electricity generating output can be stored within a battery. This is further illustrated by a stationary outer annular ring or layer 142 of an alloy material not limited to such as an iron or lithium metal. An inner contacting material layer 144 is provided (such as an aluminum based or other as provided herein) and which can be rotated in a direction referenced by arrow 143. In particular, reference to an electrothermal heat pump application, a battery 146 receives electrical charge, such as via lines 148, 150 and 152 which are communicated at circumferential locations, via respective copper or like constructed conductors 149, 151 and 153, to the outer stationary ring 143 in proximity to the interface established with the inner rotating ring 144.

FIGS. 14-16 present a further series of envisioned cross sectional and interface profiles, see as respectively shown at 154, 156 and 158, established between paramagnetic materials according to still further desired variants. In the instance of FIG. 14, the represented interface is illustrated by a magnetic core element 160 extending diagonally in cross section relative to an outer aluminum-based material construction 162, and which is in turn encased within an outer material not limited to a non-magnetic conductive material 164.

In the instance of FIG. 15, opposing layers can include (again by non-limiting representation) an upper aluminum layer 166 and a lower opposing iron layer 168. Each of these include opposing stepped surfacing profiles (see recessed at 170 for upper layer 166 and protruding at 172 for lower layer 168). In the further instance of FIG. 16 (again at 158), an upper layer 174 (such as which can include without limitation an aluminum material) is configured opposing a lower magnetic or electromagnetic layer 176, the layers 174/176 also depicting opposing stepped surfacing profiles similar to as shown in FIG. 15 which would permit the materials to be displaced reciprocally or otherwise such as depicted in any of the examples of FIGS. 10-13. As further shown, one or more stepped boundary layers 178 of a suitable conductive or other paramagnetic material can be configured between the opposing layers 174 and 176.

The devices, materials, and compositions herein are identified for providing a net change in temperature due to the response of the materials and compositions to an applied electrical current and/or a magnetic field. The change in temperature can be achieved in some aspects by movement of the components of the device, and in some aspects the movement relative to other parts of the device allows for a change in temperature in the materials and/or compositions. It will be appreciated that the devices need not be limited by scale or size to achieve a desired temperature change. It will be further apparent to those skilled in the art that while the temperature changes may be localized in the materials and/or compositions, the temperature change can be transported, such as through radiation or conduction. Accordingly, the materials and/or compositions can be utilized in most applications where a temperature change is desired. It will be further appreciated that the devices described herein can be present in a larger machine in multiple copies and/or with other devices as set forth herein to provide a larger change in temperature. For example, two devices experiencing a change of temperature of 5° C. can be harnessed to be combined to provide a greater change of temperature. Similarly, when multiple devices as set forth herein are utilized, they can be run synchronously or asynchronously or in alternating fashion, depending on the desired output.

It will be apparent to those in the art that the devices, assemblies and interfaces can be utilized and applied in numerous larger components designed to provide heat or cooling to an area or a space, such as an industrial area, a commercial area or a residential area. The device, materials and compositions herein can further be adapted for use in an appliance wherein temperature change is desired, such as with refrigeration and cooking appliances. The devices, materials and compositions can similarly be adapted for application to heating or cooling liquids, such as with radiator systems, water heaters and engine cooling. For example, applications of the above-described arrangements of the present technology can include, without limitation, each of the following as set forth in Table 6, including industrial, commercial, and residential applications.

TABLE 6

| HEATING | | | |
|---|---|---|---|
| AIR | LIQUID | SURFACE | COOLING |
| Radiant Heaters | Water Heaters | Cooking | Refrigeration |
| | | Equipment | |
| Dehumidifiers | Dishwashers | Indoor/Outdoor | Air |
| | | Grills | Conditioning |
| Dryers | Boilers | Irons | Transport A/C |
| Furnaces | Tea Kettle | Deep Fryers | Container A/C |
| Vehicle Heaters | Cappuccino, | Cooking | Chillers |
| (trucking, railway, | Expresso, | Ranges | |
| automobiles, | Coffee | | |
| RVs . . .) | Machine, | | |
| Transport Heaters | Washers/ | Ovens | Freezer |
| (aircraft, | Washing | | |
| ship/boats . . .) | Machines | | |
| Manufactured | Steamers | Toasters | Cooling |
| Homes Heaters | | | towers |
| Hair Dryers | Fluid Heat | Bread | HVAC |
| | Pumps | makers | |
| Heat Generating | Refrigerant | Tool | Intercooler |
| Equipment | Heat Pumps | Pre-heaters | |
| Hair Dryers | Rice/Food | Mold | Refrigerated |
| | Steamer | Preheaters | rail cars |
| | (cooking | | |
| | vegetables, rice, | | |
| | etc.) | | |
| Food processing | Heat therapy | Extruder | Cold chain |
| | for body pain, | Rollers | |
| | stiffness, | | |
| | spasms | | |
| | inflammation | | |
| Air ovens | | Heat Staking | |
| | | Equipment | |
| Defrost Heater | | | |
| Heating in | | | |
| Agriculture & | | | |
| Horticulture | | | |
| Greenhouse | | | |
| Heating | | | |

Other and additional envisioned applications of the afore-mentioned aspects can include adapting the present device, compositions and/or materials for use in other magnetocaloric heat pump applications, such again utilizing the magnetocaloric effect (MCE) to provide either of heating or cooling properties resulting from the magnetization (heat) or demagnetization (cold) cycles. The goal in such applications is to achieve a coefficient of performance (COP) (defined as a ratio of useful heating or cooling provided to work required) which is greater than 1.0. In such an application, the system operates to convert work to heat as well as additionally pumping heat from a heat source to where the heat is required (and factoring in all power consuming auxiliaries).

As is further understood in the relevant technical art, increasing the COP (such as potentially to a range of 2.0-3.5 or upwards) further results in significantly reduced operating costs in relation to the relatively small input electrical cost required for rotating the conductive plate(s) relative to the magnetic plate(s). Magnetic refrigeration techniques result in a cooling technology based on the magnetocaloric effect and which can be harnessed to attain extremely low temperatures within ranges used in common refrigerators, such as without limitation in order to reconfigure the present system as a fluid chiller, air cooler, active magnetic regenerator or air conditioner.

As described herein, the magnetocaloric effect is a magneto-thermodynamic phenomenon in which a temperature change of a suitable material is again caused by exposing the material to a changing magnetic field, such being further known by low temperature physicists as adiabatic (defined as occurring without gain or loss of heat) demagnetization. In that part of the refrigeration process, a decrease in the strength of an externally applied magnetic field allows the magnetic domains of a magnetocaloric material to become disoriented from the magnetic field by the agitating action of the thermal energy (phonons) present in the material. If the material is isolated so that no energy is allowed to (re)migrate into the material during this time, (i.e., again the adiabatic process) the temperature drops as the domains absorb the thermal energy to perform their reorientation. The randomization of the domains occurs in a similar fashion to the randomization at the Curie temperature of a ferromagnetic, ferrimagnetic, antiferromagnetic, paramagnetic or diamagnetic material, except that magnetic dipoles overcome a decreasing external magnetic field while energy remains constant, instead of magnetic domains being disrupted from internal ferromagnetism, ferrimagnetism, antiferromagnetism, (or either of paramagnetism/diamagnetism) as energy is added. Applications of this technology can include, and not by way of limitation, the ability to heat a suitable conductive material or alloy arranged inside of a magnetic field as is known in the relevant technical art, generating eddy currents (also known as Joule currents) which losses generate heat which is transferred to the surrounding environment or fluid in contact.

Other envisioned applications include the ability to generate heat for conditioning any fluid (not limited to water) utilizing either individually or in combination rare earth magnets or electromagnets placed into a high frequency oscillating magnetic field as well as static electromagnetic field source systems including such as energized electromagnet assemblies which, in specific instances, can be combined together within a suitable assembly not limited to that described and illustrated herein and for any type of electric induction, electromagnetic and magnetic induction application. It is further envisioned that the present assembly can be applied to any material which is magnetized, such including any of diamagnetic, paramagnetic, and ferromagnetic, ferrimagnetic or antiferromagnetic materials without exemption also referred to as magnetocaloric materials (MEMS).

Additional factors include the ability to reconfigure the assembly so that the frictionally heated fluid existing between the overlapping rotating magnetic and stationary fluid communicating conductive plates may also include the provision of additional fluid mediums (both gaseous and liquid state) for better converting the heat or cooling configurations disclosed herein. Other envisioned applications can include the provision of capacitive and resistance (ohmic power loss) designs applicable to all materials/different configurations as disclosed herein.

Other heat/cooling adjustment variables can involve modifying the degree of magnetic friction created, such as by varying the distance between the conductive fluid circulating disk packages and alternating arranged magnetic/electromagnetic plates. A further variable can include limiting the exposure of the conductive fluid (gas, liquid, etc.,) to the conductive component/linearly spaced disk packages, such that a no flow condition may result in raising the temperature (and which can be controllable for certain periods of time).

It is further generally understood in the technical art that for rare earth magnet performance operating temperature ranges are limited to Curie temperatures of the materials and/or compositions and/or components of the devices, with magnetic properties associated with losses possible or occurring above this temperature. Accordingly, rare earth magnets, including such as neodymium magnets, can achieve temperature ranges upwards of 900° C. to 1000° C.

Ferromagnetic, ferrimagnetic, antiferromagnetic, paramagnetic or diamagnetic materials, such as again which can be integrated into the conductive plates, can include any of Iron (Fe) having a Curie temperature of 1043 degrees Kelvin (K), Cobalt (Co) having a Curie temperature of 1400 K, Nickel (Ni) having a Curie temperatures of 627 K and Gadolinium (Gd) having a Curie temperature of 292 K. Curie point, also called Curie Temperature, defines a temperature at which certain magnetic materials undergo a sharp change in their magnetic properties. In the case of rocks and minerals, remanent magnetism appears below the Curie point—about 570° C. (1,060° F.) for the common magnetic mineral magnetite. Below the Curie point—by non-limiting example, 770° C. (1,418° F.) for iron—atoms that behave as tiny magnets spontaneously align themselves in certain magnetic materials.

In ferromagnetic materials, such as pure iron, the atomic magnets are oriented within each microscopic region (domain) in the same direction, so that their magnetic fields reinforce each other. In antiferromagnetic materials, atomic magnets alternate in opposite directions, so that their magnetic fields cancel each other. In ferrimagnetic materials, the spontaneous arrangement is a combination of both patterns, usually involving two different magnetic atoms, so that only partial reinforcement of magnetic fields occurs.

Given such, raising the temperature to the Curie point for any of the materials in these three classes entirely disrupts the various spontaneous arrangements, and only a weak kind of more general magnetic behavior, called paramagnetism, remains. As is further understood in the art, one of the highest Curie points is 1,121° C. (2,050° F.) for cobalt. Temperature increases above the Curie point produce paramagnetism, when these materials are cooled below their Curie points, magnetic atoms spontaneously realign so that the ferromagnetism, antiferromagnetism, or ferrimagnetism revives. As is further known, the antiferromagnetic Curie point is also referenced as the Neel temperature.

Other factors or variables controlling the temperature output can include the strength of the magnets/electromagnets which are incorporated into the devices, such as again by selected rare earth magnets having varying properties or, alternatively, by adjusting the factors associated with the use of electromagnets including an amount of current through the coils, adjusting the core ferromagnetic properties (again though material selection) or by adjusting the cold winding density around the associated core.

Other temperature adjustment variables can include modifying the size, number, location and orientation of the devices, compositions and/or materials as set forth herein (elongated and plural magnet/electromagnet and alternative conductive plates). Multiple units or devices can also be stacked, tiered or otherwise ganged in order to multiply a given volume of conditioned fluid which is produced.

Additional variables can include varying the designing of the conductive disk packages, such as not limited varying a thickness, positioning or configuration of a blade or other fluid flow redirecting profile integrated into the conductive plates, as well as utilizing the varying material properties associated with different metals or alloys, such including ferromagnetic, ferrimagnetic, antiferromagnetic, paramagnetic and diamagnetic properties.

Other and additional aspects and applications will become apparent to those skilled in the art to which it pertains, and without deviating from the scope of the appended claims. The detailed description and drawings are further understood to be supportive of the disclosure, the scope of which being defined by the claims. The Figures are not necessarily to scale. However, it is to be understood that the disclosed aspects are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific aspects and methods described herein, as specific components and/or conditions may, of course, vary. Furthermore, the terminology used herein is used only for the purpose of describing particular aspects of the present invention and is not intended to be limiting in any way. It will be also understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein. Similarly, as used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Throughout this application, where publications are referenced, the full disclosures of these publications in their entireties are hereby incorporated by reference into this application.

1. A paramagnetic material of the formula MₐX_{b} wherein a is from 0.5 to 0.99 and b is 1-a, wherein M is selected from the group consisting of Al, La, Li, Mg, Na, Sn, W, V, Ca, Nd, Tb, Dy, Ho, Pd, Ge, Zn, Fe, Co, Ni, Rh, Sn, Te, Cr, Zr, Mn, Ti, or a combination thereof, said material configured for use in a thermoelectric, inductive, or magnetocaloric cooling and/or heating apparatus.

2. The paramagnetic material of claim 1, wherein said material is Pauli-paramagnetic.

3. The paramagnetic material of claim 1, wherein M comprises Al as a predominant.

4. The paramagnetic material of claim 1, wherein the material has an electrical resistivity at or greater than 50 g·mΩ/m².

5. The paramagnetic material of claim 1, wherein the material has a thermal conductivity at or greater than 140 W/(m·K).

6. The paramagnetic material of claim 1, wherein the material has a specific heat of equal to or less than 1200 J/(kg K).

7. The paramagnetic material of claim 1, wherein the material has a magnetic relative permeability of equal to or less than 14, where relative permeability is the ratio of the permeability of a specific medium to the permeability of free space.

8. The paramagnetic material of claim 1, wherein the material has a mass magnetic susceptibility equal to or greater than 10⁻⁹ m³/kg.

9. The paramagnetic material of claim 1, wherein X is selected from the group consisting of copper (Cu), manganese (Mn), silicon (Si), magnesium (Mg), magnesium/silicon (MgSi), zinc (Zn), barium (Ba), cesium (Cs), cerium (Ce), lanthanum (La), lithium (Li), magnesium (Mg), manganese (Mn), potassium (K), praseodymium (Pr), samarium (Sm), sodium (Na), tin (Sn), titanium (Ti), tungsten (W), vanadium (V), or combinations thereof.

10. The paramagnetic material of claim 9, further comprising a FeCoNiCrAl alloy, a pure metal, an intra-Lanthanide alloy, an aluminide, gadolinium, palladium, a gadolinium silicide, europium sulfur, a zinc alloy, ErAgGa, a 3d transition metal, a 3d metal-based alloy and intermetallic compound, a mixed Lanthanide-3d transition metal compound, a manganese-based intermetallics, an iron-based intermetallic, a cobalt-based intermetallic, a nickel-based intermetallic, an amorphous alloy, a manganite, a magneto-caloric material (MCM), or combinations thereof.

11. A device comprising the paramagnetic material of claim 1, wherein the paramagnetic material is arranged in a shape and contacted with a magnet or magnetic composition.

12. The device of claim 11, wherein the shape is a cylinder or ring and the magnet or magnetic composition is shaped as an exterior layer to the cylinder or ring and arranged to permit motion therebetween in a rotary, linear or eccentric manner to provide inductive heating or magnetocaloric cooling and/or heating.

13. The device of claim 11, wherein the shape is a cylinder with the magnet or magnetic composition provided as an intermediate layer therein and arranged to allow either of a stationary or rotating arrangement of the cylinder relative to the intermediate layer and to provide for two direction thermal conductive transfer from the eddy currents created therebetween.

14. The device of claim 11, wherein the shape comprises a stacked plate array with sub-cylinders of the magnet or magnetic composition contained within each plate thereof, the stacked plate array being mounted on a shaft or spindle and adapted to be concurrently or selectively rotated therearound.

15. The device of claim 11, wherein the shape is a spiral with the magnet or magnetic composition arranged as an outer layer thereof with an inner end and an outer end.

16. The device of claim 11, wherein the shape is of at least one spiral shape and stacked to at least one alternate spiral in an opposing direction comprised of the magnet or magnetic composition wherein the spiral shape and the alternate spiral shape share a similar radius in width.

17. The device of claim 11, wherein the shape is arranged as at least one layer around or above an inner core or layer comprised of the magnet or magnetic composition.

18. The device of claim 17, wherein the inner core or layer comprises at least one alternating layer set of the magnet or magnetic composition and a layer of the paramagnetic composition.

19. The device of claim 11, wherein the shape is a stack of two or more offset petal shapes.

20. The device of claim 11, wherein the shape is an outer layer of at least two cylinders comprised of the magnet or magnetic composition, the cylinders being supported upon a coaxial cylindrical shaft and axially spaced apart thereon.

21. The device of claim 11, wherein the shape is an inner cylinder operable to rotate in one direction and the magnet or magnetic composition is provided as a coaxial outer cylinder operable to rotate in the other direction, wherein an intermediate coaxial non-rotating layer between the inner cylinder and the outer cylinder, wherein the intermediate coaxial non-rotating layer is comprised of the paramagnetic composition with magnetic components imbedded therein.

22. The device of claim 11, wherein the shape is an inner cylinder or ring operably rotatable to and in contact with a stationary outer annular ring or layer comprised of an alloy material, the assembly further comprising a battery conductively connected to the outer stationary annular ring at at least one point proximal to an interface between the inner cylinder or ring and the stationary outer annular ring.

23. The device of claim 11, wherein movement between the shape and the magnet or magnetic composition proximal temperature change is an increase of at least 5° C.

24. The device of claim 11, wherein movement between the shape and the magnet or magnetic composition proximal temperature change is a decrease of at least 5° C.

25. The device of claim 11, configured as a Peltier cell and further comprising a series of alternating n and p type semiconductors connected to the paramagnetic composition.

26. The device of claim 11 wherein the shape is an inner cylinder comprising embedded magnetic materials arranged about a central axis and a coaxial outer cylinder comprising the paramagnetic composition containing magnetic portions, wherein the inner cylinder and the outer cylinder are configured to rotate about the central axis in opposing directions.

27. The device of claim 26, wherein the coaxial outer cylinder embeds an irregularly shaped interfacing magnetic layer and the inner cylinder further features at least one irregular surface or portion thereof.

28. The device of claim 11, wherein the shape comprises a stepped inter-profile.

29. A material interface, comprising:
a first elongated and interiorly hollowed cylinder, being stationary mounted and constructed of a non-magnetic and conductive material with a keyed interior surface at a distal end thereof;
a first elongated component configured in a coaxial telescoping relationship with a keyed exterior to fit in the keyed interior of the first elongated and interiorly hollowed cylinder for linear reciprocating motion in a bi-axial direction;
a conductive material shaped as a cylindrical end cap shape with an enlarged annular base that embeds an exposed core of a ferritic material that further embeds a magnetic core, the end cap operably rotatable within an open bottom at a proximal end of the first elongated and interiorly hollowed cylinder concurrent with the axial reciprocating motion of the first elongated component relative to the keyed interior at the distal end of the first elongated and interiorly hollowed cylinder.
